(19) United States
(12) Patent Application Publication
(10) Pub. No.: US 2006/0240305 A1
(43) Pub. Date: Oct. 26, 2006

(54) Bipolar plate and fuel cell assembly having same

(75) Inventor: Chuan-De Huang, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/399,801

(22) Filed: Apr. 7, 2006

(30) Foreign Application Priority Data
Apr. 22, 2005 (CN) 200510034353.4

(51) Int. Cl. H01M 8/02; B32B 15/04; B32B 15/08

(52) U.S. Cl. 429/34; 428/457; 429/38

(57) ABSTRACT

The present invention relates to a bipolar plate (130) for fuel cells. The bipolar plate includes a metal plate (131) and a composite layer (132) formed thereon. The composite layer includes a composition made of a polymer resin and a carbon nanomaterial. The carbon nanomaterial is selected from the group consisting of carbon nanoparticles, carbon nanotubes, carbon fibers, carbon nanohorns and carbon fullerenes. The present invention also provides a fuel cell assembly (1000) includes a number of membrane electrode assemblies (110), a number of above-described bipolar plates and a number of gas diffusing layers (120).

### BACKGROUND

1. Technical Field

The invention relates generally to bipolar plates, and more particularly, to a bipolar plate made of a metal and a carbon nanomaterial and a fuel cell assembly having the same.

2. Discussion of Related Art

Fuel cells are devices in which an electrochemical reaction is used to generate electricity A variety of materials including hydrogen, methanol or formaldehyde are attractive choices for fuels due to their high specific energies and ease-of-storage. According to the operating temperatures and electrolytes used, fuel cells can be classified into various categories including polymer electrolyte fuel cells (PEFC) or proton exchange membrane fuel cells (PEMFC), alkali fuel cells (AFC), phosphoric acid fuel cells (PAFC), molten carbonate fuel cells (MCFC), and solid oxide fuel cells (SOFC).

The basic configuration of a fuel cell, for example, a proton exchange membrane fuel cell, includes a plurality of cell units. The cell unit of a PEMFC includes a proton exchange membrane (PEM) and two electrodes, i.e. an anode and a cathode provided at two sides of the PEM. In addition, a polar plate is attached to each of the electrodes. After tightly combining all the above elements together, a fuel cell unit is formed.

To make fuel cell use practical, a plurality of the above cell units will usually be stacked and connected in series to provide sufficient power. Therefore, two neighboring cell units can share a common polar plate, which serves as the anode and the cathode for the two neighboring cell units. Accordingly, such a polar plate is usually referred to as a bipolar plate.

Generally, two sides of the bipolar plate are provided with many grooves for channeling the reaction gases, such as hydrogen and air (to provide oxygen), which also serve to remove the exhaust products, such as water droplets or vapor, out of the bipolar plate. Conventionally, bipolar plates are made of pure graphite or graphite composite. Thus, the grooves on the graphite plate are usually formed by additional mechanical machining which require complicated processes and considerable expense. In addition, if the graphite plate is made by the compression molding of graphite powder, it must be further coated with resin or other material to seal the voids between the powder granules. Furthermore, due to the requirements for adequate mechanical strength and durability, the graphite plate cannot be very thin, so the overall dimensions of the fuel cell cannot be reduced.

What is needed, therefore, is a bipolar plate having a thin cross-section, light mass and good chemical resistance.

### SUMMARY

The present invention provides a bipolar plate for fuel cells. In one embodiment, the bipolar plate includes a metal plate with a composite layer formed thereon. The metal plate is selected from the group consisting of copper, aluminum, nickel, stainless steel and any combination alloy thereof The thickness of the metal plate is in the range from 0.1 mllimeters to 0.5 millimeters. The composite layer includes a composition made of a polymer resin and a carbon nanomaterial incorporated in the polymer resin. The carbon nanomaterial is selected from the group consisting of carbon nanoparticles, carbon nanotubes, carbon fibers, carbon nanohorns and carbon fullerenes. The composite layer has a number of grooves defined therein.

A fuel cell assembly includes a number of membrane electrode assemblies, a number of bipolar plates and a number of gas diffusing layers. The membrane electrode assemblies and the bipolar plates are arranged in an alternate fashion, each of the bipolar plates including a metal plate and a composite layer formed on the metal plate. The composite layer is comprised of a polymer resin and a carbon nanomaterial incorporated in the polymer resin. Each gas diffusing layer is sandwiched between a respective membrane electrode assembly and a corresponding adjacent bipolar plate.

Advantages and novel features of the present bipolar plate will become more apparent from the following detailed description of preferred embodiments when taken in conjunction with the accompanying drawings.

### BRIEF DESCRIPTION OF THE DRAWINGS

Many aspects of the present bipolar plate and related fuel cell assembly can be better understood with reference to the following drawings. The components in the drawings are not necessarily drawn to scale, the emphasis instead being placed upon clearly illustrating the principles of the present invention.

FIG. 1 is a schematic, cross-sectional view of a metal plate and composite layers formed thereon for a dipolar plate in accordance with a first preferred embodiment;

FIG. 2 is the similar as in FIG. 1, but showing the bipolar plate with a number of grooves defined therein;

FIG. 3 is a schematic, cross-sectional view of a metal plate and carbon nanotubes formed thereon for a dipolar plate in accordance with a second preferred embodiment;

FIG. 4 is the similar as in FIG. 3, but showing polymer resins filling the gaps between the carbon nanotubes to form a composite layer;

FIG. 5 is the similar as in FIG. 4, but showing a number of grooves formed therein; and

FIG. 6 is a schematic, cross-sectional view of a segment of a fuel cell assembly having the bipolar plate of FIG. 2.

Corresponding reference characters indicate corresponding parts throughout the several views. The exemplifications set out herein illustrate at least one preferred embodiment of the present bipolar plate and fuel cell using the same, in one form, and such exemplifications are not to be construed as limiting the scope of the invention in any manner.

### DETAILED DESCRIPTION OF PREFERRED EMBODIMENTS

Reference will now be made to the drawings to describe embodiments of the present bipolar plate and related fuel cell assembly, in detail.

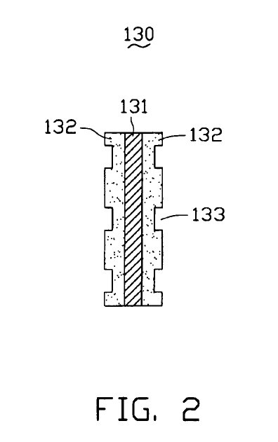

Referring to FIG. 2, a bipolar plate 130 according to a first preferred embodiment is shown. The bipolar plate 130 includes a metal plate 131 and a composite layer 132 formed on the metal plate 131. The metal plate 131 is made of a metallic material selected from the group consisting of copper, aluminum, nickel, stainless steel and any combination alloy thereof The thickness of the metal plate 131 is in a range from 0.1 millimeters to 0.5 millimeters.

The composite layers 132 are formed on two opposite surfaces of the metal plate 131. Each of the composite layers 132 is composed of a polymer resin and a carbon nanomaterial incorporated in the polymer resin. The polymer resin is selected from the group of thermoplastic resin, thermosetting resin and fluorinated resin. The carbon nanomaterial is selected from the group consisting of carbon nanoparticles, carbon nanotubes, carbon fibers, carbon nanohorns and carbon fullerenes. The composite layer 132 has a number of grooves defined therein.

A method for making the bipolar plate 130 includes the steps of: providing a metal plate 131; forming a composite layer 132 on the metal plate 131; and defining a number of grooves 133 in the composite layer.

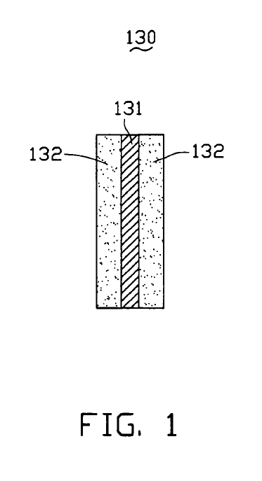

Referring to FIG. 1, the composite layer 132 is formed by mixing carbon nanomaterials and a polymer resin at first. The polymer resin functions as a matrix in which the carbon nanomaterial is embedded. The polymer resin is either a thermoplastic, a fluorinated or a thermosetting resin. Thermoplastic resins include polypropylene copolymers, high-density polyethylene, polyacrylonitrile and silicone elastomers. Fluorinated resins include polyvinylidene fluoride and polychlorotrifluoroethylene (Aclon. TM. made by Honeywell). Thermosetting resins include epoxy and polyester amide. The polymer resin is preferably in a powder form that is sieved through a mesh size (U.S. Standard ASTME 11-61) of about 10 to about 100.

The carbon nanomaterial is mixed into the polymer resin to form a composite mixture. The composite mixture may be blended in order to obtain a homogeneous mixture. The composite layer 132 can be formed on the metal plate 131 by painting the composite mixture onto the metal plate 131 or dipping the metal plate 131 in a solution of the composite mixture.

A hot press molding method is utilized to form a number of grooves 133 on the bipolar plate 130 as in FIG. 2. The mold (not shown) used can be any mold compatible with the size, shape and surface requirements for the bipolar plate 130. During the molding step, the number of grooves 133 can be pressed and molded onto the composite layer 132. Alternately, the grooves 133 can be micro-carved onto the composite layer 132.

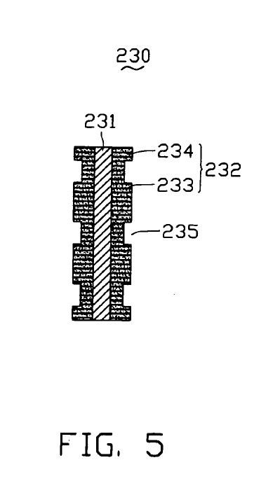

A second embodiment of a bipolar plate 230 is shown in FIG. 5. The bipolar plate 230 includes a metal plate 231 with two opposite composite layers 232 formed thereon. The metal plate 231 is made of a material selected from the group consisting of copper, aluminum, nickel, stainless steel and any combination alloy thereof. The thickness of the metal plate 231 is in a range from 0.1 millimeters to 0.5 millimeters.

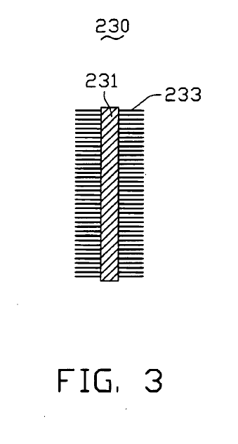

The composite layers 232 are formed on surfaces of the metal plate 231. The composite layer 232 is made of carbon nanotubes and a polymer resin. Referring to FIG. 3, the carbon nanotubes 233 are formed on the metal plate 231 by a plasma enhanced chemical vapor deposition method giving total control over location and morphology of the nanotubes. Carbon nanotubes are extremely thin, hollow cylinders made of carbon atoms, with a shape equivalent to a two dimensional sheet rolled into a tube. Carbon nanotubes exhibit extraordinary mechanical properties: having a Young's modulus of well over 1 tera pascal and a the tensile strength of more than 200 giga pascal.

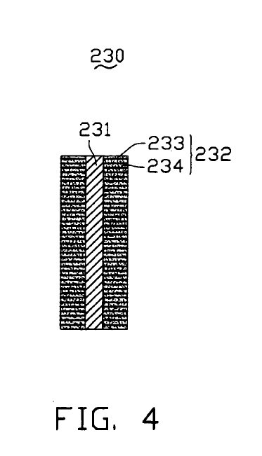

Referring to FIG. 4, the metal plate 231 and carbon nanotubes 233 thereon are dipped into a polymer resin solution to form a composite layer 232. The polymer resin is either a thermoplastic, a fluorinated or a thermosetting resin. Thermoplastic resins include polypropylene copolymers, high-density polyethylene, polyacrylonitrile and silicone elastomers. Fluorinated resins include polyvinylidene fluoride and polychlorotrifluoroethylene (Aclon.TM. made by Honeywell). Thermosetting resins include epoxy and polyester amide. The polymer resin may be in a powder form that is sieved through a mesh with a mesh size (U.S. Standard ASTME 11-61) of about 10 to about 100.

A number of grooves 235 can be pressed onto the composite layer 232 by a hot press molding method as in FIG. 5. Alternately, the number of grooves 235 can be micro carved onto the composite layer 232.

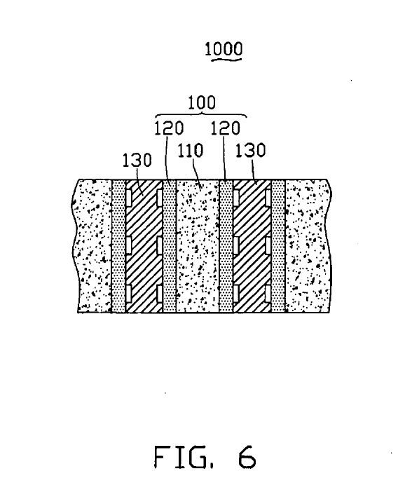

Referring to FIG. 6, a fuel cell assembly 1000 having the present bipolar plate 130 is shown. The fuel cell assembly 1000 includes a plurality of membrane electrode assemblies 110, a plurality of bipolar plates 130, and a plurality of gas diffusing layers 120. The membrane electrode assemblies 110 and the bipolar plates 130 are arranged in an alternate fashion. Also referring to FIG. 2, each of the bipolar plates 130 includes a metal plate 131 and a composite layer 132 formed on the metal plate 131, the composite layer 132 being comprised of a polymer resin and a carbon nanomaterial incorporated in the polymer resin. The gas diffusing layers 120 each are sandwiched between a respective membrane electrode assembly 110 and a corresponding adjacent bipolar plate 130.

As such, the fuel cell assembly 1000 consists of a plurality of unit 100. Each unit 100 includes a membrane electrode assembly 110, two gas diffusing layers 120 and two half parts of two respective bipolar plates 130. The membrane electrode assembly 110 has an anode, a cathode and an electrolyte membrane. The membrane electrode assembly 110 is in the middle of each unit 100, with the two sides thereof provided with the gas diffusing layers 120.

Generally, the two sides of the bipolar plate 130 are provided with many grooves for promoting transportation of the reaction gases, such as hydrogen and air; and as well as removing the waste products, such as water droplets or vapor out of the bipolar plate 130.

Compared with conventional bipolar plates, the present bipolar plate is made of metal and composite carbon nanomaterials. Metallic material can provide sufficient mechanical strength and carbon nanomaterials have adequate electric conductivity and chemical resistance. Therefore, the thickness of the present bipolar plate can be significantly reduced, thus reducing also the overall dimensions and weight of the fuel cell.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

I claim:

1. A bipolar plate for fuel cells, comprising:
a metal plate; and
a composite layer formed on the metal plate, the composite layer being comprised of a polymer resin with a carbon nanomaterial incorporated in the polymer resin.

2. The bipolar plate as claimed in claim 1, wherein the carbon nanomaterial is selected from the group consisting of carbon nanoparticles, carbon nanotubes, carbon fibers, carbon nanohorns and carbon fullerenes.

3. The bipolar plate as claimed in claim 1, wherein the polymer resin is selected from the group consisting of thermoplastic resin, thermosetting resin and fluorinated resin.

4. The bipolar plate as claimed in claim 1, wherein the metal plate is comprised of a metal selected from the group consisting of copper, aluminum, nickel, stainless steel and any combination alloy thereof.

5. The bipolar plate as claimed in claim 1, wherein a thickness of the metal plate is in the range from 0.1 millimeters to 0.5 millimeters.

6. The bipolar plate as claimed in claim 1, wherein the composite layers are formed on opposite surfaces of the metal plate.

7. The bipolar plate as claimed in claim 1, wherein the composite layer has a plurality of grooves defined therein.

8. A fuel cell assembly comprising:
a plurality of membrane electrode assemblies;
a plurality of bipolar plates, the membrane electrode assemblies and the bipolar plates being arranged in an alternate fashion, each of the bipolar plates comprising a metal plate and a composite layer formed on the metal plate, the composite layer being comprised of a polymer resin and a carbon nanomaterial incorporated in the polymer resin; and
a plurality of gas diffusing layers, the gas diffusing layers each being sandwiched between a respective membrane electrode assembly and a corresponding adjacent bipolar plate.

9. The fuel cell assembly as claimed in claim 8, wherein the carbon nanomaterial is selected from the group consisting of carbon nanoparticles, carbon nanotubes, carbon fibers, carbon nanohorns and carbon fullerenes.

10. The fuel cell assembly as claimed in claim 8, wherein the polymer resin is selected from the group consisting of thermoplastic resin, thermosetting resin and fluorinated resin.

11. The fuel cell as claimed in claim 8, wherein the metal plate is comprised of a metal selected from the group consisting of copper, aluminum, nickel, stainless steel and any combination alloy thereof.

12. The fuel cell assembly as claimed in claim 8, wherein the composite layer has a plurality of grooves defined therein.
